(19) United States
(12) Patent Application Publication
(10) Pub. No.: US 2014/0118268 A1
(43) Pub. Date: May 1, 2014

(54) TOUCH SCREEN OPERATION USING ADDITIONAL INPUTS

(71) Applicant: Google Inc., Mountain View, CA (US)

(72) Inventor: Alexander Friedrich KUSCHER, San Francisco, CA (US)

(73) Assignee: Google Inc., Mountain View, CA (US)

(21) Appl. No.: 13/666,824

(22) Filed: Nov. 1, 2012

(51) Int. Cl. G06F 3/041

(52) U.S. Cl. 345/173

(57) ABSTRACT

Aspects of the subject technology relate to systems, methods, and machine-readable media for operating a touch-sensitive device using additional inputs. A system can be configured to detect a touch interaction at a location on a touch-sensitive device associated with a display, receive additional sensor input for the touch-sensitive device, the additional sensor input corresponding to the touch interaction, determine vision characteristics of a user of the touch-sensitive device based on the additional sensor input, and process the touch interaction based on location of the touch interaction and the vision characteristics of the user.

### BACKGROUND

The present disclosure generally relates to determining user intent and to tracking user movements on a touch-sensitive input device.

A touch screen is an electronic display that is able to detect the presence and location of a contact area caused by an object (e.g., a finger, a hand, or a stylus). The touch screen display can include a number of interface elements that a user can interact with by “touching” the interface element on the touch screen display. For example, the user may move a finger across the surface of the touch screen to move or select items displayed on the touch screen. Touch screens are used on a variety of devices, such as smart phones, mobile device, tablets, laptops, or desktop computers, and come in a variety of sizes.

### SUMMARY

Aspects of the subject technology relate to a computer-implemented method for responding to a touch interaction. The method includes detecting a touch interaction at a location on a touch-sensitive device associated with a display, receiving additional sensor input for the touch-sensitive device, the additional sensor input corresponding to the touch interaction, determining vision characteristics of a user of the touch-sensitive device based on the additional sensor input, and processing the touch interaction based on location of the touch interaction and the vision characteristics of the user.

Additional aspects of the subject technology relate to a system for responding to a touch interaction. The system includes one or more processors and a machine-readable medium comprising instructions stored therein, which when executed by the one or more processors, cause the one or more processors to perform operations. The operations include detecting a touch interaction at a location on a touch screen device associated with a display. receiving additional sensor input from the touch screen device, the additional sensor input corresponding to the touch interaction, determining vision characteristics of a user of the touch screen device based on the additional sensor input, and processing the touch interaction based on location of the touch interaction and the vision characteristics of the user.

Aspects of the subject technology may also relate to a non-transitory machine-readable medium comprising instructions stored therein, which when executed by a machine, cause the machine to perform operations for responding to a touch interaction. The operations include detecting a touch interaction at a location on a touch-sensitive device associated with a display, receiving at least one image for the touch-sensitive device, the at least one image corresponding to the touch interaction, determining vision characteristics of a user of the touch-sensitive device based on the at least one image, and processing the touch interaction based on location of the touch interaction and the vision characteristics of the user.

Aspects of the subject technology relate to a computer-implemented method for arranging interface elements on a touch screen display. The method includes receiving sensor input from a sensing device associated with a touch screen, determining whether an object obscures the touch screen from a user's view based on the sensor input, identifying, if the object obscures the touch screen, an area on the touch screen display that is not obscured by the object, and displaying one or more visual elements in the area on the touch screen that is not obscured by the object.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example system configured to process a touch interaction using visual input, in accordance with various aspects of the subject technology.

FIG. 2 is a diagram illustrating an example touch screen, according to various aspects of the subject technology.

FIG. 3A is a diagrams illustrating an example touch screen, according to various aspects of the subject technology.

FIG. 3B is a diagrams illustrating an example touch screen, according to various aspects of the subject technology.

FIG. 4 is a flowchart illustrating an example process for responding to a touch interaction, in accordance with various aspects of the subject technology.

FIG. 5 is a block diagram illustrating an example computer system with which any of the systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

A user may input commands to a computing system via a touch screen. In some cases, however, the touch interaction that is detected by the touch screen may be too large or imprecise to accurately determine which user interface element a user intends to interact with. For example, a user may touch a portion of a touch screen display that covers more than one interface element and it may be unclear which interface element the user intends to interact with. Furthermore, a user's hand or arm may obscure portions of the touch screen display near where the user is touching.

Various aspects of the subject technology relate to enhancing touch screen interactions based on addition sources of input. For example, visual input from a camera or other optical device may be used to determine visual characteristics of a user such as the positions of the user's eyes or the direction that the user's eyes are looking Touch interactions may then be processed based on the visual characteristics of the user.

In some aspects, the visual characteristics may be used to identify an interface element on the touch screen that the user is looking at and, if the interface element corresponds to the touch interaction, the touch interaction will be processed. According to other aspects, the visual characteristics may be used to determine where to display interface elements such that they are not obscured by objects such as a user's hand or arm.

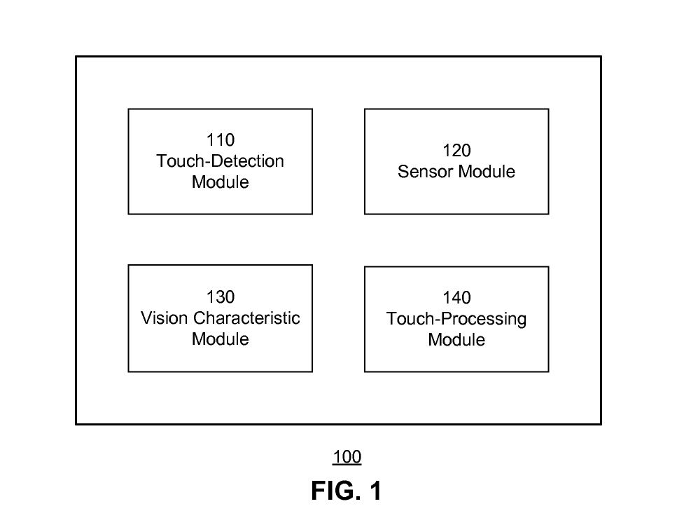

FIG. 1 is a block diagram illustrating an example system 100 configured to process a touch interaction using additional input, in accordance with various aspects of the subject technology. The system 100 may be any computing machine with, for example, one or more processors, memory, communications abilities, etc. Example systems 100 may include a desktop computer, a laptop, a tablet, mobile devices (e.g., a smart phone or a global positioning system device), a gaming device, a television, etc. The system 100 includes a touch-detection module 110, a sensor module 120, a vision characteristic module 130, and a touch-processing module 140.

The touch-detection module 110 may include or interface with a touch-sensitive input device such as a touch screen. The touch-detection module 110 is configured to detect a touch interaction on the touch-sensitive input device and determine the position of the touch interaction. A touch interaction may include the presence of an object (e.g., a finger, a palm, another appendage, or a stylus) on the surface of the touch-sensitive input device. For example, the touch-detection module 110 may determine that an area on the surface of the touch-sensitive input device is in contact with a user's finger and convert the contacted area into coordinates (e.g., (x,y) coordinates).

The sensor module 120 may include or interface with one or more input devices including, for example, optical input devices (e.g., cameras or infrared cameras) or other devices (e.g., proximity sensors). The optical input devices or other devices may be a part of the system 100 or in communication with the system 100. The vision characteristic module 130 is configured to receive input for the input devices from the sensor module 120 and determine vision characteristics of the user based on the received input. Vision characteristics may include, for example, the position of the user's eyes relative to a display (e.g., the touch screen display), a direction in which the user's eyes are looking, or whether objects are obscuring the user's view of the display.

The touch-processing module 140 is configured to use the vision characteristics to process a touch interaction detected by the touch-detection module 110. For example, according to some aspects, the sensor module 120 may receive a one or more images of a user's face and eyes that are taken by a camera. The time that the one or more images were taken may correspond to when (or near when) the user touches a touch screen display.

The vision characteristic module 130 may determine, based on the one or more images, vision characteristics such as the position and direction of the user's eyes when the touch interaction was detected. Based on the relative position of the camera to the touch screen display and the position and direction of the user's eyes in the one or more images, the touch-processing module 140 can determine an area on the touch screen display that the user is looking at (e.g., a focus area). If an interface element on the touch screen display is located at or near the position of the focus area, the user may be considered to be focusing on the interface element.

The touch-processing module 140 can determine whether the position of the interface element that the user is focused on is at or near the location of the user's touch interaction. If the position of the focused upon interface element is overlaps or is within a certain threshold distance of the touch interaction, the user likely intended to touch the interface element. Accordingly, the touch-processing module 140 will process the user's touch interaction.

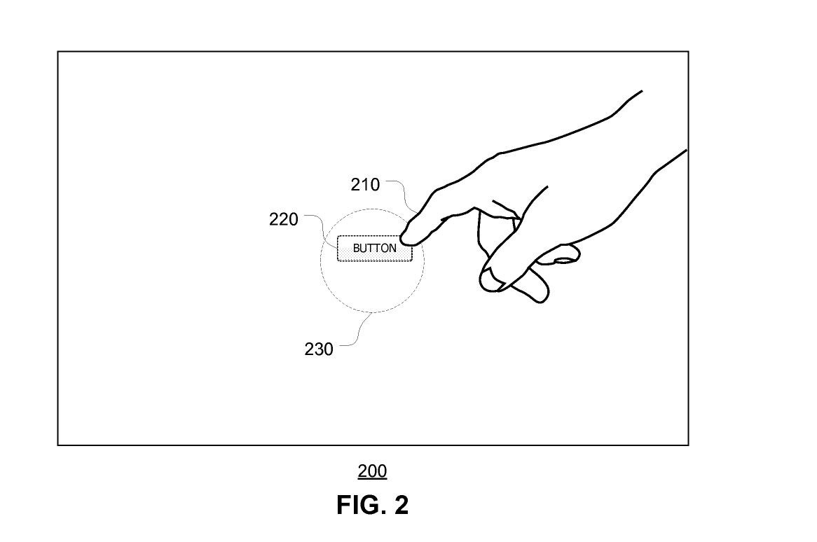

FIG. 2 is a diagram illustrating an example touch screen 200, according to various aspects of the subject technology. The touch screen 200 includes an interface element 220 (e.g., a button) that a user can interact with via a touch interaction 210. FIG. 2 also shows a focus area 230 of the user, which covers the area where the interface element 220 is located. Accordingly, the user may be considered to be focusing on the interface element 230. Because the focused upon interface element 230 overlaps the location of the touch interaction 210, the touch-processing module 140 will process the touch interaction 210 (e.g., the button 220 will be pressed).

In one variation, if the position of the focused upon interface element does not overlap or is not within a certain threshold distance of the location of the touch interaction, the user may have accidentally touched the touch screen display or intended to touch a different interface element. Accordingly, the system will not process the touch interaction for the focused upon interface element. By taking into consideration a user's focus area as well as a touch interaction, the system may be able to determine with greater confidence and accuracy whether a user intends to interact with an interface element on a touch screen display.

According to another aspect, the touch-processing module 140 can process a touch interaction with an interface element by displaying visual elements. For example, if a menu on a touch screen display is selected, the system may display a drop down menu with selectable options. In order to ensure that the any displayed visual elements are not obscured by the user's hand, arm, or other object, the system 100 may attempt to locate any objects that may obscure the user's view and present the visual elements in an area not obscured by the objects. Visual elements may include, for example, additional interface elements (e.g., buttons, the drop down menu with the selectable options, links, user interface controls, etc.), pop-ups, thumbnails or icons that are displayed when being dragged, images, or any other visual content that may be displayed on a display.

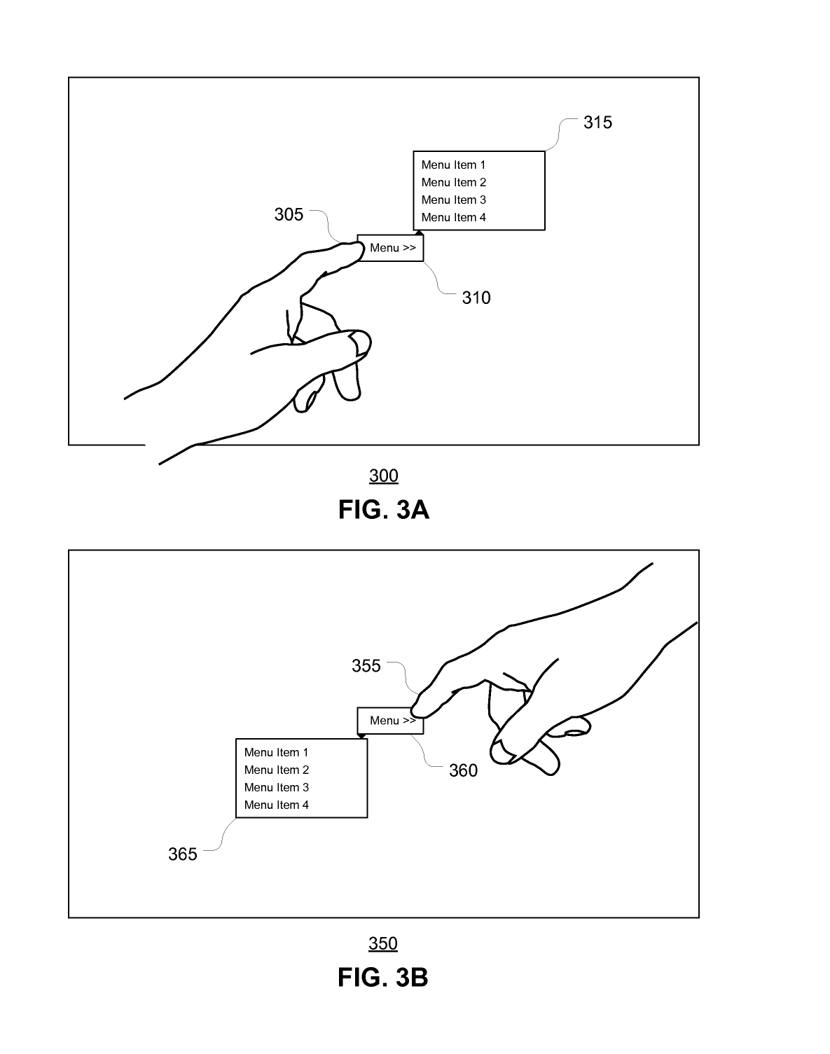

FIG. 3A and FIG. 3B are a diagrams illustrating example touch screens 300 and 350, according to various aspects of the subject technology. FIG. 3A shows a touch screen 300 receiving a touch interaction 305 from a user, where the user's hand and arm obscure the user's view of an area located at the bottom left quadrant from the interface element 310 (e.g., a menu button). Accordingly, the system 100 may display additional interface elements 315 (e.g., selectable menu options) in an area not obscured by the user's hand and arm (e.g., an upper right quadrant from the interface element 310).

In another example, FIG. 3B shows a touch screen 350 receiving a touch interaction 355 from a user, where the user's hand and arm obscure the user's view of an area located at the upper right quadrant from the interface element 360. Accordingly, the system 100 may display additional interface elements 365 in an area not obscured by the user's hand and arm (e.g., a bottom left quadrant from the interface element 360).

To this end, the sensor module 120 may receive input from one or more proximity sensors, infrared cameras, or a combination of devices. The vision characteristic module 130 may determine, based on the input from the sensor module 120, vision characteristics such as the location of objects detected by the input devices, the size of the objects, or the distance of the objects from the touch screen. According to some aspects, the vision characteristic module 130 may also determine vision characteristics, such as eye position, eye direction, and the location of the obscuring objects, using a camera. Based on the vision characteristics, the touch-processing module 140 can determine whether an object obscures the user's view.

If one or more obscuring objects are found, the touch-processing module 140 can determine the location of the obscuring objects relative to the touch screen display, identify an area on the touch screen display that is not obscured by the one or more obscuring objects, and display the visual elements in the area that is not obscured.

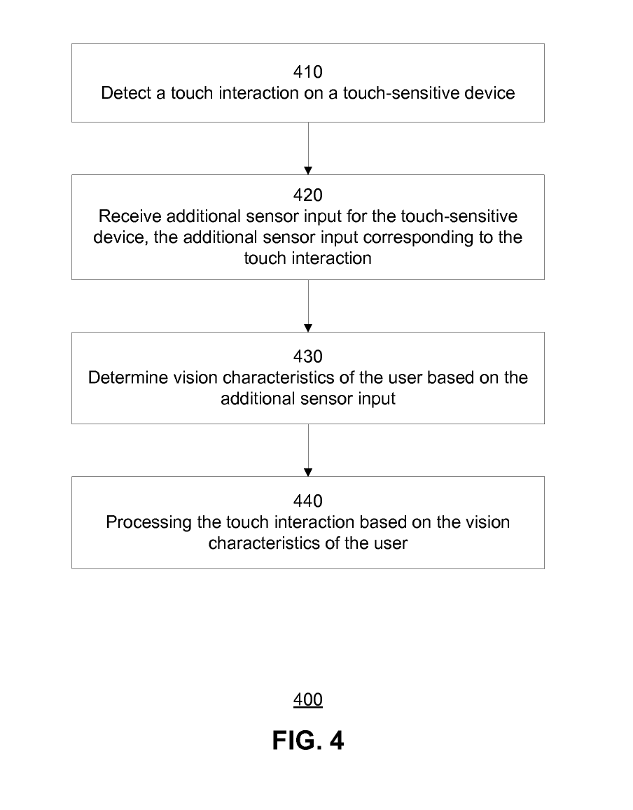

FIG. 4 is a flowchart illustrating an example process 400 for responding to a touch interaction, in accordance with various aspects of the subject technology. Although the blocks in FIG. 4 may be discussed with respect to the components of system 100 illustrated in FIG. 1, the blocks are not limited to these modules. Furthermore, although the blocks are shown in one particular order, other orderings of blocks are also possible. For example other orderings may include additional blocks, fewer blocks, or blocks that occur in parallel.

At block 410, a touch-detection module 110 can detect a touch interaction on a touch-sensitive device, such as a touch screen. During this time, or in response to the touch interaction, additional sensor input for the touch-sensitive device may be received by the sensor module 120 at block 420. The additional sensor input, according to some aspects, may be image data (e.g., pictures or video) captured by an optical device (e.g., a camera).

The additional sensor input corresponds to the touch interaction detected by the touch-detection module 110. For example, the sensor module 120 may receive an image that correspond to the same or a nearby moment in time as when the touch interaction occurred. According to some aspects, multiple images may also be received and used to increase the accuracy in determining vision characteristics for the user.

Based on the additional sensor input (e.g., the image data), the vision characteristic module 130 may determine vision characteristics of the user at block 430. Vision characteristics may include, for example, the position of the user's eyes relative to a display (e.g., the touch screen), a direction in which the user's eyes are looking, or whether objects are obscuring the user's view of the display.

In some aspects other sensors and input data may also be used to determine vision characteristics of the user. Sensors may include, for example, more proximity sensors, infrared cameras, or a combination of devices. These sensors may be used together with, or instead of, the optical device.

The touch-processing module 140 can, at block 440, process the touch interaction using the vision characteristics of the user as determined at block 430. For example, the touch-processing module 140 can identify, based on the vision characteristics of the user, an interface element on the touch screen display that is focused upon by the user. If the location of the touch interaction is within a threshold distance of the interface element, the touch-processing module 140 can process the touch interaction (e.g., allow the touch interaction to register as an instruction associated with the activation of the interface element).

In addition to, or instead of, using the vision characteristics to determine whether to process the touch interaction, the touch-processing module 140 may also use the vision characteristics to determine the manner in which the touch interaction is processed. For example, if the vision characteristics of the user indicate that one or more objects are obscuring the user's view, the touch-processing module 140 can determine the location of the obscuring objects relative to the user and/or the touch screen display and identify an area on the touch screen display that is not obscured by the one or more obscuring objects. The touch-processing module 140 can then provide for the display one or more visual elements in the area on the touch screen display that is not obscured.

Although the visual elements discussed above are displayed in response to a touch interaction, according to some aspects, the system 100 may be configured to provide for the display, in areas that are not obscured by objects, of visual elements that are not displayed in response to a touch interaction. For example, the sensor module 120 may receive sensor input from one or more sensor devices (e.g., cameras or other optical devices, proximity sensors, etc.) and the vision characteristic module 130 may determine whether one or more object are obscuring the user's view of the display.

The touch-processing module 140 can determine the location of the obscuring objects relative to the user and/or the touch screen display, identify an area on the touch screen display that is not obscured by the one or more obscuring objects, and provide for the display one or more visual elements in the area on the touch screen display that is not obscured. These visual elements may be displayed without touch interaction being detected. Some visual elements may include, for example, periodic or intermittent pop-ups or advertisements.

Although various aspects of the subject technology are described with respect to touch screens and touch interactions, these and other aspects may also be applied to other touch-sensitive input devices such as a touchpad or trackpad. Furthermore, other movement-sensitive input devices (e.g., motion detectors, game controllers, etc.) are contemplated as well.

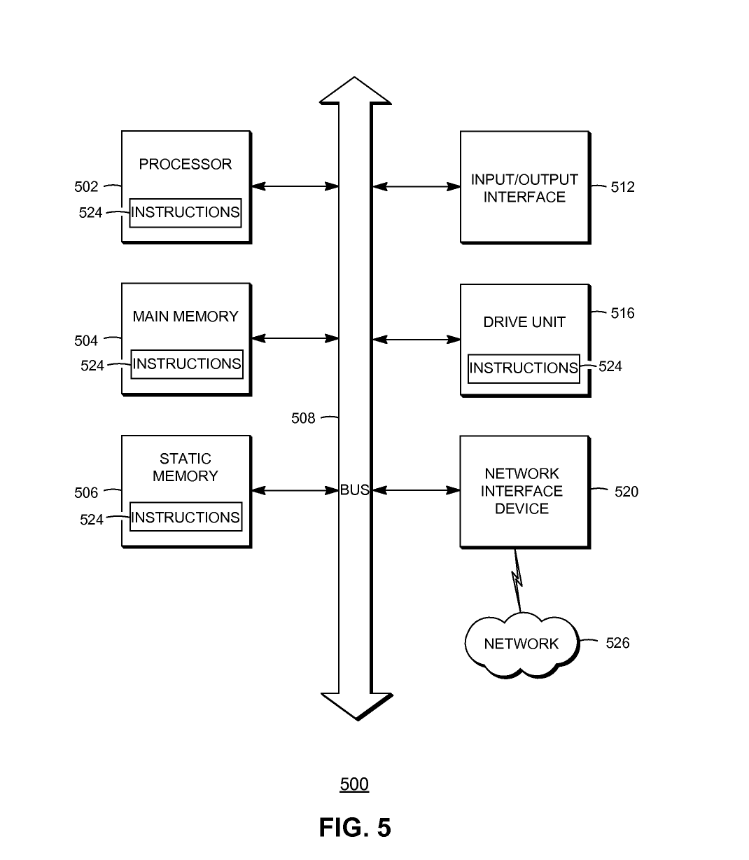

FIG. 5 is a block diagram illustrating an example computer system 500 with which any of the systems described herein may be implemented. In certain aspects, the computer system 500 may be implemented using hardware or a combination of software and hardware, either in a dedicated server, or integrated into another entity, or distributed across multiple entities.

The example computer system 500 includes a processor 502, a main memory 504, a static memory 506, a disk drive unit 516, and a network interface device 520 which communicate with each other via a bus 508. The computer system 500 may further include an input/output interface 512 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 502 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 524 embodying any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media. The instructions 524 may further be transmitted or received over a network 526 via the network interface device 520.

The machine-readable medium may be a single medium or multiple media (e.g., a centralized or distributed database, and/or associated caches and servers) that store the one or more sets of instructions. The machine-readable medium may comprise the drive unit 516, the static memory 506, the main memory 504, the processor 502, an external memory connected to the input/output interface 512, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

What is claimed is:

1. A method for responding to a touch interaction, the method comprising:
detecting a touch interaction at a location on a touch-sensitive device associated with a display;
receiving additional sensor input for the touch-sensitive device, the additional sensor input corresponding to the touch interaction;
determining vision characteristics of a user of the touch-sensitive device based on the additional sensor input; and
processing the touch interaction based on location of the touch interaction and the vision characteristics of the user.

2. The method of claim 1, wherein the additional sensor input comprises image data, from at least one camera coupled to the touch-sensitive device, associated with a time that the touch interaction occurred.

3. The method of claim 2, wherein the image data comprises at least one image taken by the at least one camera in response to detecting the touch interaction.

4. The method of claim 1, wherein the additional sensor input comprises proximity data, from a proximity sensor coupled to the touch-sensitive device, associated with a time that the touch interaction occurred.

5. The method of claim 1, wherein the vision characteristics comprise at least one of a position of the user's eyes relative to the display and a direction in which the user's eyes are looking, and wherein processing the touch interaction based on location of the touch interaction and the vision characteristics of the user comprises:
identifying a location of a focus area on the display;
determining whether an interface element on the display is located within a first threshold distance of the location of the focus area and within a second threshold distance of the location of the touch interface; and
processing the touch interaction if the interface element on the display is located within the first threshold distance of the location of the focus area and within the second threshold distance of the location of the touch interface.

6. The method of claim 5, wherein the processing of the touch interaction comprises receiving an instruction associated with the interface element.

7. The method of claim 1, wherein the vision characteristics comprise a location of an object relative to the display, and wherein processing the touch interaction based on location of the touch interaction and the vision characteristics of the user comprises:
determining, based on the vision characteristics, an object obscures the user's view;
identifying an area on the touch screen display that is not obscured from the user's view;
and providing for the display of at least one visual element in the area that is not obscured from the user's view.

8. The method of claim 7, wherein the visual element is an additional interface element.

9. The method of claim 7, wherein the vision characteristics further comprise at least one of a position of the user's eyes relative to a display and a direction in which the user's eyes are looking

10. The method of claim 1, wherein the touch-sensitive device associated with the display is a touch screen.

11. A system for responding to a touch interaction, the system comprising:
one or more processors; and
a machine-readable medium comprising instructions stored therein, which when executed by the one or more processors, cause the one or more processors to perform operations comprising:
detecting a touch interaction at a location on a touch screen device associated with a display;
receiving additional sensor input from the touch screen device, the additional sensor input corresponding to the touch interaction;
determining vision characteristics of a user of the touch screen device based on the additional sensor input; and
processing the touch interaction based on location of the touch interaction and the vision characteristics of the user.

12. The system of claim 11, wherein the additional sensor input comprises image data, from at least one camera in communication with the touch screen device, associated with a time that the touch interaction occurred.

13. The system of claim 11, wherein the additional sensor input comprises proximity data, from a proximity sensor in communication with the touch screen device, associated with a time that the touch interaction occurred.

14. The system of claim 11, wherein the vision characteristics comprise at least one of a position of the user's eyes relative to the display and a direction in which the user's eyes are looking, and wherein processing the touch interaction based on location of the touch interaction and the vision characteristics of the user comprises:
identifying a location of a focus area on the display;
determining whether the focus area is located within a first threshold distance of the location of the touch interface; and
processing the touch interaction if the focus area is located within a first threshold distance of the location of the touch interface.

15. The system of claim 11, wherein the vision characteristics comprise a location of an object relative to the display, and wherein processing the touch interaction based on location of the touch interaction and the vision characteristics of the user comprises:
determining, based on the vision characteristics, an object obscures the user's view;
identifying an area on the touch screen display that is not obscured from the user's view; and
providing for the display of at least one visual element in the area that is not obscured from the user's view.

16. A machine-readable medium comprising instructions stored therein, which when executed by a machine, cause the machine to perform operations comprising:
detecting a touch interaction at a location on a touch-sensitive device associated with a display;
receiving at least one image for the touch-sensitive device, the at least one image corresponding to the touch interaction;
determining vision characteristics of a user of the touch-sensitive device based on the at least one image; and
processing the touch interaction based on location of the touch interaction and the vision characteristics of the user.

17. The machine-readable medium of claim 16, wherein the vision characteristics comprise at least one of a position of the user's eyes relative to a display and a direction in which the user's eyes are looking, and wherein processing the touch interaction based on location of the touch interaction and the vision characteristics of the user comprises:
identifying a location of a focus area on the display;
determining whether the focus area is located within a first threshold distance of the location of the touch interface; and
processing the touch interaction if the focus area is located within a first threshold distance of the location of the touch interface.

18. The machine-readable medium of claim 16, wherein the vision characteristics comprise a location of an object relative to the display, and wherein processing the touch interaction based on location of the touch interaction and the vision characteristics of the user comprises:
identifying, based on the vision characteristics, an area on the touch screen display that is not obscured from the user's view; and
providing for the display of at least one visual element in the area that is not obscured from the user's view.

19. A method for arranging interface elements on a touch screen display, the method comprising:
receiving sensor input from a sensing device associated with a touch screen;
determining whether an object obscures the touch screen from a user's view based on the sensor input;
identifying, if the object obscures the touch screen, an area on the touch screen display that is not obscured by the object; and
displaying one or more visual elements in the area on the touch screen that is not obscured by the object.

20. The method of claim 19, further comprising:
detecting a touch interaction on the touch screen; and
wherein the displaying of the one or more visual elements is in response to the detecting of the touch interaction.
